(19) United States
(12) Patent Application Publication
(10) Pub. No.: US 2020/0211000 A1
(43) Pub. Date: Jul. 2, 2020

(54) BLOCKCHAIN NETWORK AND NODES FOR TRACKING DEVICE AS A SERVICE OPERATIONS

(71) Applicant: Wipro Limited, Bangalore (IN)

(72) Inventor: Parthasarathy Narasimhan, Bangalore (IN)

(21) Appl. No.: 16/275,533

(22) Filed: Feb. 14, 2019

(30) Foreign Application Priority Data
Dec. 26, 2018 (IN) 201841049125

(51) Int. Cl. G06Q 20/38; G06Q 30/06; G06Q 30/04; G06Q 20/40; G06Q 20/14; G06Q 10/08

(52) U.S. Cl. CPC G06Q 20/389; G06Q 30/0635; G06Q 30/04; H04L 63/08; G06Q 20/14; G06Q 10/087; G06Q 20/40

(57) ABSTRACT

A blockchain network for tracking device as a service operation is disclosed. The blockchain network includes a plurality of peer nodes and each peer nodes further include a processor and a memory includes a smart contract that includes processor instructions that cause the processor to verify digital identity of users accessing the blockchain network and validate data shared by each user accessing the blockchain network. Processor instructions further cause the processor to automatically process an order associated with the request initiated by the initiator node for the device as a service and create a unique transaction ID associated with the order. Processor instructions cause the processor to update an order status associated with the order based on the unique ID, reconciliate fulfillment claims with an invoice associated with the order, and process payments associated with the order in response to the reconciliating.

This application claims the benefit of Indian Patent Application Serial No. 201841049125, filed Dec. 26, 2018, which is hereby incorporated by reference in its entirety.

### FIELD

This disclosure relates generally to distributed ledger networks and more particularly to blockchain network and nodes for tracking device as a service operations.

### BACKGROUND

Device as a service is a service offered for backend operations to support device fulfilment requests, for example, end user computing devices. The device as a service operations are provided by multiple vendors and partners, like service providers, which includes stocking team, proposal team, procurement team, customer team, and vendors who supply devices based on orders received from the service providers for fulfilling the device request initiated by a customer.

At any given time, there may be multiple providers of device as a service for supporting various regions and countries across the globe. In these situations, the customer may have difficulties in getting clear visibility of the device fulfilment requests and their respective status. Moreover, conventional solutions have multiple problems. These problems may include delayed information sharing. Since there may be multiple parties and stakeholders in the overall device as a service operations and there is a great amount of dependency on each of these stakeholders to provide information, the device order and shipment information is not available in real-time. These problems may also include poor visibility of device request. Due to delay in information availability between the stakeholders, the visibility of the device fulfilment is poor. These problems may further include delayed approval process. The required approvals for procurement may be obtained manually or over email, which delays the overall approval process by few days.

In device as a service operation, when multiple entities/teams operating on multiple systems with lack of visibility of device requests to fulfilment are engaged, there may be no single source of truth. This may lead to disputes in invoice reconciliation and settlement. Further, there may be inability to track assets end to end from request to fulfillment leading to reconciliation issues and discrepancy in delivery due to incorrect ordering and lack of transparency in operations. Moreover, long lead time in approval leads to delay in procurement and there is difficulty in managing the orderable, stockable product catalog per country, which may lead to ordering end of life parts.

### SUMMARY

In one embodiment, a blockchain network for tracking device as a service operation is disclosed. The blockchain network includes a plurality of peer nodes, wherein a request for a device as a service is initiated from an initiator node within the plurality of peer nodes. Each of the plurality of peer nodes further include a processor and a memory that further includes a copy of a shared ledger, wherein the copy of the shared ledger is synced with each copy of the shared ledger amongst the plurality of peer nodes. The memory further includes a smart contract that includes processor instructions which when executed by the processor cause the processor to verify digital identity of users accessing the blockchain network through at least one of the plurality of peer nodes. The processor instructions further cause the processor to validate data shared by each user accessing the blockchain network through at least one of the plurality of peer nodes. The processor instructions cause the processor to automatically process an order associated with the request initiated by the initiator node for the device as a service. The processor instructions further cause the processor to create a unique transaction identifier (ID) associated with the order, in response to processing the order. The processor instructions cause the processor to update an order status associated with the order based on the unique ID in the copy of the shared ledger. The processor instructions further cause the processor to reconciliate fulfillment claims with an invoice associated with the order. The processor instructions cause the processor to process payments associated with the order in response to the reconciliating.

In another embodiment, a computing node in a blockchain network for tracking device as a service operation is disclosed. The computing node includes a processor and a memory that includes a copy of a shared ledger, wherein the copy of the shared ledger is synced with each copy of the shared ledger amongst the plurality of peer nodes. The memory further includes a smart contract that includes processor instructions which when executed by the processor cause the processor to the processor to verify digital identity of users accessing the blockchain network through at least one of the plurality of peer nodes. The processor instructions further cause the processor to validate data shared by each user accessing the blockchain network through at least one of the plurality of peer nodes. The processor instructions cause the processor to automatically process an order associated with the request initiated by the initiator node for the device as a service. The processor instructions further cause the processor to create a unique transaction identifier (ID) associated with the order, in response to processing the order. The processor instructions cause the processor to update an order status associated with the order based on the unique ID in the copy of the shared ledger. The processor instructions further cause the processor to reconciliate fulfillment claims with an invoice associated with the order. The processor instructions cause the processor to process payments associated with the order in response to the reconciliating.

In yet another embodiment, a non-transitory computer-readable storage medium having stored thereon, a set of computer-executable instructions causing a computer comprising one or more processors to perform steps that include verifying digital identity of users accessing the blockchain network through at least one of the plurality of peer nodes; validating data shared by each user accessing the blockchain network through at least one of the plurality of peer nodes; automatically processing an order associated with the request initiated by the initiator node for the device as a service; creating a unique transaction identifier (ID) associated with the order, in response to processing the order; updating an order status associated with the order based on the unique ID in the copy of the shared ledger; reconciliating fulfillment claims with an invoice associated with the order; or processing payments associated with the order in response to the reconciliating.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 illustrates a blockchain network in which various embodiments may be employed.

FIG. 2 illustrates a Blockchain network for tracking device as a service operations, in accordance with an embodiment.

FIG. 3 illustrates a block diagram of a computing node in a Blockchain network that is configured to track device as a service operations, in accordance with an embodiment.

FIG. 4 illustrates a flowchart of a method for tracking device as a service operation in a Blockchain network, in accordance with an embodiment.

FIG. 5 illustrates a flowchart of a method for automatically processing an order associated with a request initiated by a computing node for a device as a service, in accordance with an embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

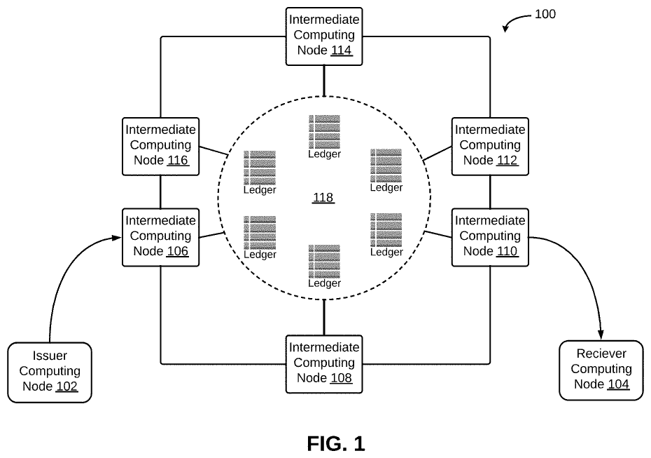

Additional illustrative embodiments are listed below. In one embodiment, a Blockchain network 100, in which various embodiments may be employed, is illustrated in FIG. 1. It will be apparent to a person skilled in the art that the invention is not limited to the blockchain network 100 and is relevant to all variations and implementations of the Blockchain network 100, for example, the Hashgraph network.

In the Blockchain network 100, an issuer computing node 102 associated with a sender entity (not shown in FIG. 1) initiates a Blockchain transaction for a receiver computing node 104 associated with a receiver entity (not shown in FIG. 1). The Blockchain transaction may include, but is not limited to, a clearing transaction, or a settlement transaction. It will be apparent to a person skilled in the art that the Blockchain network 100 may include multiple issuer and receiver computing nodes.

The Blockchain network 100 also includes a plurality of intermediate computing nodes, for example, an intermediate computing node 106, an intermediate computing node 108, an intermediate computing node 110, an intermediate computing node 112, an intermediate computing node 114, and an intermediate computing node 116. It will be apparent to a person skilled in the art that the issuer computing node 102 and the receiver computing node 104 are technically similar to each of the plurality of intermediate computing nodes and only differ by way of the performed functionalities.

Each of the issuer computing node 102, the receiver computing node 104, and the plurality of intermediate computing nodes are capable of running one or more applications and establishing communication with other computing nodes. Examples of computing nodes may include, but are not limited to a computer, a smart phone, a Personal Digital Assistant (PDA), a laptop, a tablet and so forth.

In order to initiate a Blockchain transaction, the issuer computing node 102 uses cryptographic tools to digitally sign a proposed update to a ledger 118 (which is shared across the plurality of intermediate computing nodes). In an exemplary scenario, the previously mentioned Blockchain transaction may correspond to a payment transaction. In such a scenario, the ledger 118 may be used for transferring funds from an account on the ledger 118 to an account associated with an entity owning the receiver computing node 104. As depicted in FIG. 1, upon receiving the transfer request, the intermediate computing node 106 may authenticate identity of the issuer computing node 102 and validates the Blockchain transaction by checking that the issuer computing node 102 has necessary cryptographic credentials to make an update to the ledger 118. Validation of the Blockchain transaction may also include verifying whether the issuer computing node 102 has sufficient funds to make the payment and fulfill the Blockchain transaction.

In a similar manner, each of the remaining plurality of intermediate computing nodes authenticate identity of the issuer computing node 102 and validate the Blockchain transaction. Based on this, the plurality of intermediate computing nodes initiates a consensus process in order to agree on the payments that should be included in the next update to the ledger 118. The consensus process ensures that no two intermediate computing nodes have conflicting records of the ledger 118. Once the update to the ledger 118 has been accepted by each of the plurality of intermediate computing nodes, the Blockchain transaction is processed and the account associated with an entity owning receiver the computing node 104 receives the payment.

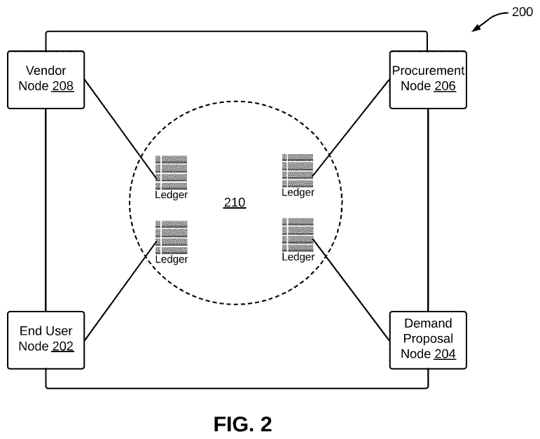

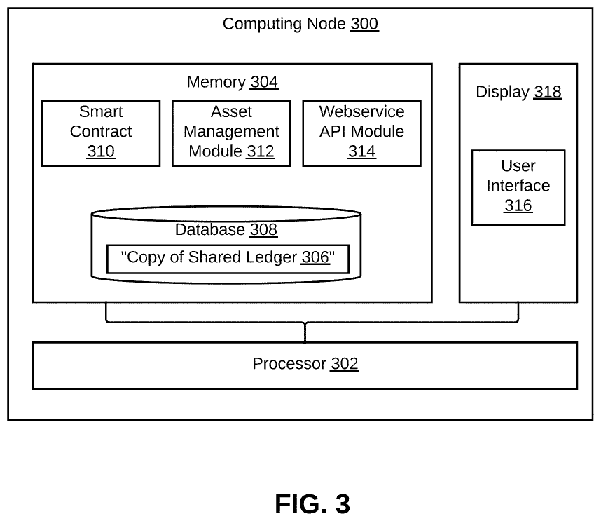

Referring now to FIG. 2, a Blockchain network 200 for tracking device as a service operations is illustrated, in accordance with an embodiment. The Blockchain network 200 enables sharing information related to device fulfilment in the device as a service. The Blockchain network 200 may include four peer permissioned Blockchain networks on Hyperledger fabric. The Blockchain network 200 includes a plurality of peer nodes, such that, each of the plurality of peer nodes are assigned a plurality of roles that may include, but are not limited to an end user role, a vendor role, a demand proposal role, and a procurement role. Thus, the plurality of peer nodes include an end user node 202, a demand proposal node 204, a procurement node 206, and a vendor node 208, such that, each of these peer nodes is associated with one of the four peer permissioned Blockchain networks. Further, each of the nodes 202-208 is further associated with a local database (not shown in FIG. 2), an asset management system (not shown in FIG. 2), and a user interface (not shown in FIG. 2). This is further explained in detail in conjunction with FIG. 3.

The end user node 202 is directly connected with a shared ledger 210. Similarly, each of the demand proposal node 204, the procurement node 206, and the vendor node 208 is also connected with the shared ledger 210. In an embodiment, each of the nodes 202-208 may include a local copy of the shared ledger 210, which may be periodically synced with the shared ledger 210. All stakeholders in the device as a service operations join the Blockchain network 200 through an associated node in the Blockchain network 200. By way of an example, the stocking team and proposal team join through the demand proposal node 204, the procurement team joins through the procurement node 206, the client end user approval team joins through the end user node 202, and the vendor team joins through the vendor node 208.

A device as a service operation is initiated from the end user node 202 (which may also be termed as an initiator node), when an end-user creates a request for a device as a service, for example, a desktop computer. When there is stock available in the warehouse associated with the end-user, the stocking team may allocate the device to the end user and may complete fulfilment of the device as a service operation. However, when there is no required stock in the warehouse to fulfil the device requests created by the end-user, the proposal team, via the demand proposal node 204 may create a new proposal for procurement of the device as a service. The new proposal is routed to the end user node 202, in order to get required approval from an approving office associated with the end-user.

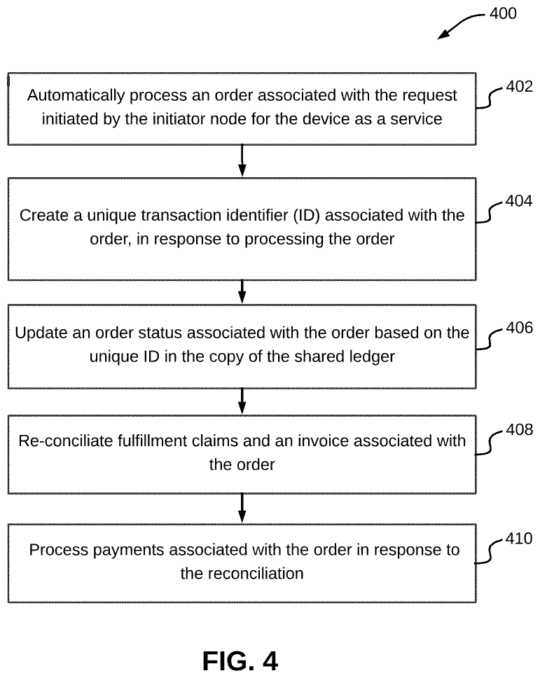

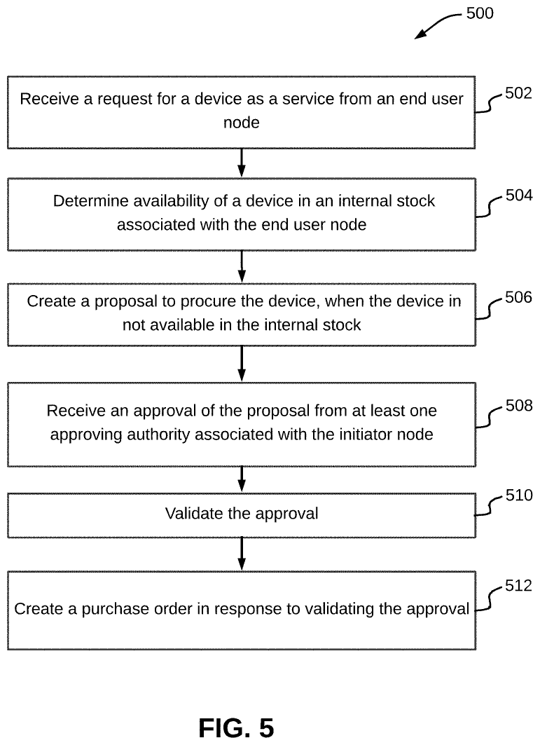

Once the approval is obtained from the approval officer, the proposal team, via the demand proposal node 204, shares the new proposal with a procurement team through the procurement node 206. The procurement node 206 after verifying and validating the approvals, places a new purchase order with a vendor who supplies the device as a service, through the vendor node 208. The vendor, through the vendor node 208, receives the purchase order and updates the shipment and delivery information. All the information between the nodes 202-208 is shared through the shared ledger 210. Thus, the shared information is made available to each of the nodes 202-208. On receipt of delivery of the device as a service from the vendor, the stocking team, through the demand proposal node 204, may update the shared ledger 210 and may confirm receipt of the device as a service. Additionally, the stocking team, through the demand proposal node 204, allocates the device as a service to the end user in order to complete the fulfilment of the request initiated by the end user node 202. This is further explained in detail in conjunction with FIG. 4 and FIG. 5.

Referring now to FIG. 3, a block diagram of a computing node 300 in the Blockchain network 200 that is configured to track device as a service operations is illustrated, in accordance with an embodiment. The computing node 300 may represent each of the end user node 202, the demand proposal node 204, the procurement node 206, and the vendor node 208.

The computing node 300 include a processor 302 that is coupled to a memory 304. The memory 304 stores instructions for the processor 302, which, on execution, causes the processor 302 to perform desired operations. The memory 304 may be a non-volatile memory or a volatile memory. Examples of the non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

In order to enable the computing node 300 to track device as a service, the memory 304 includes a copy of the shared ledger 306 in a database 308, a smart contract 310, an asset management module 312, and a webservice Application Programming Interface (API) module 314.

The copy of the shared ledger 306 is periodically synced with the shared ledger 210. The smart contract 310 includes processor instructions which when executed by the processor 302 cause the processor to selectively execute one or more operations on the information stored in the shared ledger 210. The one or more operations may include verifying digital identity of users accessing the blockchain network through at least one of the plurality of peer nodes. The one or more operations may further include validating data shared by each user accessing the blockchain network through at least one of the plurality of peer nodes. The one or more operations may include automatically processing an order associated with the request initiated by the initiator node for the device as a service. The one or more operations may further include creating a unique transaction identifier (ID) associated with the order, in response to processing the order. The one or more operations may include updating an order status associated with the order based on the unique ID in the copy of the shared ledger. The one or more operations may further include reconciliating fulfillment claims with an invoice associated with the order. The one or more operations may include processing payments associated with the order in response to the reconciliating. This is further explained in detail in conjunction with FIG. 4 and FIG. 5.

Since the copy of the shared ledger 210 is available with each of the plurality of peer nodes and is validated using the smart contract 310, there is no ambiguity on the information shared. The smart contract 310 automate the verification and validation of the required business rules to complete transactions created on the Blockchain network 300. The smart contract 310 is run by each of the plurality of peer nodes, which are authorized to endorse transactions as per endorsement policy written on the blockchain governance mechanism. As a result, the real state of the shared ledger 210 and the transactions on the shared ledger 210 are authenticated by each of the plurality of peer nodes and thus become immutable.

The asset management module 312 enables stakeholders, via associated peer nodes to track and manage fulfillment of a request for a device as a service. The asset management module 312, via the webservice API module 314, may connect to an integration layer (not shown in FIG. 3). The integration layer further connects the computing node 302 to the Blockchain network 200. A stakeholder may interact with an asset management system rendered by way of the asset management module 312, on a User Interface (UI) 316. The UI 316 of the asset management system may be displayed on a display 318 of the computing node 300. The UI 316 may show approved demand proposals and associated purchase order data extracted from the shared ledger 210. The UI 316 is access controlled, such that, through the UI 316, a global user may see all data and a local user may see country specific data.

Referring now to FIG. 4, a flowchart of a method 400 for tracking device as a service operation in the Blockchain network 200 is illustrated, in accordance with an embodiment. One or more processor instructions in the smarts contracts stored in each of a plurality of peer nodes, enable the processor 302 to perform the method 400, based on information stored in the shared ledger 210. At step 402, an order associated with a request initiated by an initiator node for a device as a service, is automatically processed. The initiator node, for example, may be the end user node 202. In response to processing the order, at step 404, a unique transaction identifier (ID) associated with the order is created. Based on the unique ID, an order status associated with the order is updated in the copy of the shared ledger, at step 406. Updating the order status may include updating shipping and delivery information associated with the order in the shared ledger 210.

At step 408, fulfillment claims are reconciliated with an invoice associated with the order. Reconciliating the fulfillment claims with the invoice may further include confirming a reconciled invoice. In response to the reconciliating, at step 410, payments associated with the order is processed. Processing the payments may further include authorizing the payments based on the reconciled invoice.

Referring now to FIG. 5, a flowchart of a method 500 for automatically processing an order associated with a request initiated by a computing node for a device as a service is illustrated, in accordance with an embodiment. One or more processor instructions in the smarts contracts stored in each of a plurality of peer nodes, enable the processor 302 to perform the method 500, based on information stored in the shared ledger 210. At step 502, a request for a device as a service is received from an initiator node (for example, the end user node 202). At step 504, availability of a device is determined in an internal stock associated with the initiator node. The UI 316 may be used to determine the same. When the device is not available in the internal stock, at step 506, a proposal to procure the device is created. Thereafter, an approval of the proposal is received from at least one approving authority associated with the initiator node, at step 508. The approval is then validated at step 510. In response to validating the approval, a purchase order is created at step 512.

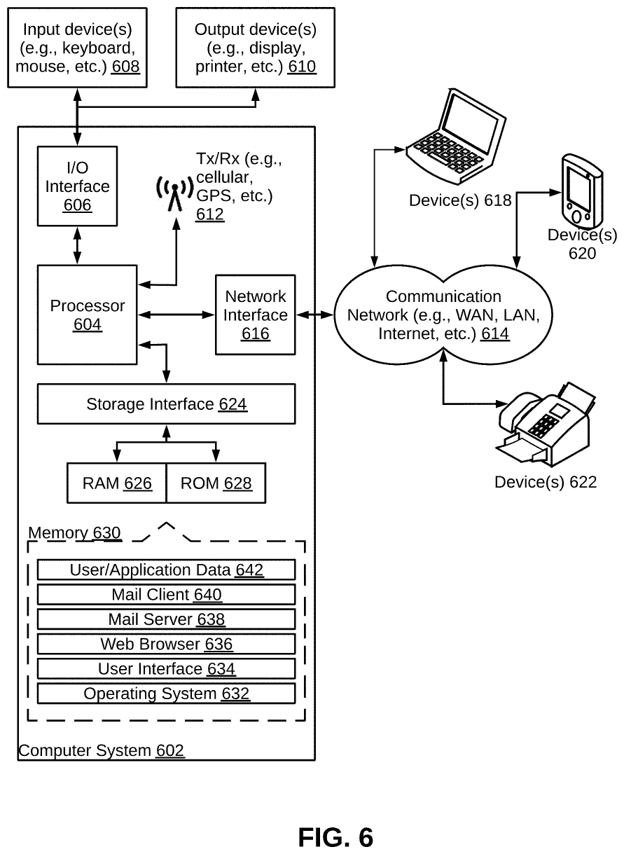

Referring now to FIG. 6, a block diagram of an exemplary computer system for implementing various embodiments is illustrated. Computer system 602 may include a central processing unit (“CPU” or “processor”) 604 that includes at least one data processor for executing program components for executing user-generated requests or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 610 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed relating to processor 604. Transceiver 612 may facilitate various types of wireless transmission or reception. For example, transceiver 612 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (e.g., using Wireless Application Protocol), the Internet, etc. Using network interface 616 and communication network 614, computer system 602 may communicate with devices 618, 620, and 622. The devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of the devices.

In some embodiments, processor 604 may be disposed in communication with one or more memory devices (e.g., RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (e.g., any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/6/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide a blockchain network and nodes for tracking device as a service operations. The invention provides complete visibility to end users along with increased trust and transparency, which is enabled by the Blockchain technology. The Blockchain network enhances transparency and traceability across the value chain. Records on shared ledger are immutable as they are validated by all peer nodes. Each node includes smart contracts that technically endorse all records provided by all nodes in the shared ledger. A UI is used to represent shared ledger data and updated status of records associated with an order for a device as a service. Authentication and authorization for nodes is performed using cryptographic security and records are updated through Webservice directly from an asset management system. There is near real-time visibility in end to end cycle beginning from proposal approval. Moreover, a single source for providing verified records directly from system is provided, thereby eliminating manual error.

The specification has described a blockchain network and nodes for tracking device as a service operations. The illustrated steps are set out to explain the exemplary embodiments shown, and it should be anticipated that ongoing technological development will change the way functions are performed. Examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A blockchain network for tracking device as a service operation, the blockchain network comprising:
a plurality of peer nodes, wherein a request for a device as a service is initiated from an initiator node within the plurality of peer nodes, and wherein each of the plurality of peer nodes comprise:
a processor; and
a memory comprising:
a copy of a shared ledger, wherein the copy of the shared ledger is synced with each copy of the shared ledger amongst the plurality of peer nodes; and
a smart contract comprising processor instructions which when executed by the processor cause the processor to perform at least one of:
verifying digital identity of users accessing the blockchain network through at least one of the plurality of peer nodes;
validating data shared by each user accessing the blockchain network through at least one of the plurality of peer nodes;
automatically processing an order associated with the request initiated by the initiator node for the device as a service;
creating a unique transaction identifier (ID) associated with the order, in response to processing the order;
updating an order status associated with the order based on the unique ID in the copy of the shared ledger;
reconciliating fulfillment claims with an invoice associated with the order; or
processing payments associated with the order in response to the reconciliating.

2. The blockchain network of claim 1, wherein the plurality of peer nodes are assigned a plurality of roles.

3. The blockchain network of claim 2, wherein the plurality of roles comprises an end user role, a vendor role, a demand proposal role, and a procurement role.

4. The blockchain network of claim 2, wherein the processor selectively executes one or more of the processor instructions based on one of the plurality of nodes assigned to an associated peer node in the plurality of peer nodes.

5. The blockchain network of claim 1, wherein the reconciliating the fulfillment claims with the invoice comprises confirming a reconciled invoice.

6. The blockchain network of claim 5, wherein the processing the payments further comprises authorizing the payments based on the reconciled invoice.

7. The blockchain network of claim 1, wherein the updating the order status comprises updating shipping and delivery information associated with the order.

8. The blockchain network of claim 1, wherein the processing the order comprises determining availability of the device as a service in an internal stock associated with the initiator node.

9. The blockchain network of claim 8, wherein the processing the order further comprises:
creating a proposal to procure the device, when the device in not available in the internal stock;
receiving an approval of the proposal from at least one approving authority associated with the initiator node;
validating the approval; and
creating a purchase order in response to validating the approval.

10. The blockchain network of claim 1, wherein a hyperledger fabric technology is used to support the blockchain network.

11. A computing node in a blockchain network for tracking device as a service operation, the computing node comprising:
a processor; and
a memory comprising:
a copy of a shared ledger, wherein the copy of the shared ledger is synced with each copy of the shared ledger amongst the plurality of peer nodes; and
a smart contract comprising processor instructions which when executed by the processor cause the processor to perform at least one of:
verifying digital identity of users accessing the blockchain network through at least one of the plurality of peer nodes;
validating data shared by each user accessing the blockchain network through at least one of the plurality of peer nodes;
automatically processing an order associated with the request initiated by the initiator node for the device as a service;
creating a unique transaction identifier (ID) associated with the order, in response to processing the order;
updating an order status associated with the order based on the unique ID in the copy of the shared ledger;
reconciliating fulfillment claims with an invoice associated with the order; or
processing payments associated with the order in response to the reconciliating.

12. The computing node of claim 11, wherein the plurality of peer nodes are assigned a plurality of roles.

13. The computing node of claim 12, wherein the processor selectively executes one or more of the processor instructions based on one of the plurality of nodes assigned to an associated peer node in the plurality of peer nodes.

14. The computing node of claim 11, wherein the reconciliating the fulfillment claims with the invoice comprises confirming a reconciled invoice.

15. The computing node of claim 14, wherein the processing the payments further comprises authorizing the payments based on the reconciled invoice.

16. The computing node of claim 11, wherein the updating the order status comprises updating shipping and delivery information associated with the order.

17. The computing node of claim 11, wherein the processing the order comprises determining availability of the device as a service in an internal stock associated with the initiator node.

18. The computing node of claim 17, wherein the processing the order further comprises:
creating a proposal to procure the device, when the device in not available in the internal stock;
receiving an approval of the proposal from at least one approving authority associated with the initiator node;
validating the approval; and
creating a purchase order in response to validating the approval.

19. The computing node of claim 11, wherein a hyperledger fabric technology is used to support the blockchain network.

20. A non-transitory computer-readable storage medium having stored thereon, a set of computer-executable instructions causing a computer comprising one or more processors to perform steps comprising:
verifying digital identity of users accessing the blockchain network through at least one of the plurality of peer nodes;
validating data shared by each user accessing the blockchain network through at least one of the plurality of peer nodes;
automatically processing an order associated with the request initiated by the initiator node for the device as a service;
creating a unique transaction identifier (ID) associated with the order, in response to processing the order;
updating an order status associated with the order based on the unique ID in the copy of the shared ledger;
reconciliating fulfillment claims with an invoice associated with the order; or
processing payments associated with the order in response to the reconciliating.
